(19) United States
(12) Patent Application Publication
(10) Pub. No.: US 2017/0140393 A1
(43) Pub. Date: May 18, 2017

(54) ATTRIBUTION OF COST CHANGES USING MULTIPLE FACTORS

(71) Applicant: International Business Machines Corporation, Armonk, NY (US)

(72) Inventors: Dmitriy A. Katz-Rogozhnikov, Ossining, NY (US); Aleksandra Mojsilovic, New York, NY (US); Karthikeyan Natesan Ramamurthy, Yorktown Heights, NY (US); Dennis Wei, White Plains, NY (US); Gigi Y. Yuen-Reed, Tampa, FL (US)

(21) Appl. No.: 14/940,560

(22) Filed: Nov. 13, 2015

(51) Int. Cl. G06Q 30/02; G06Q 40/08; G06F 17/30

(52) U.S. Cl. CPC G06Q 30/0201; G06F 17/30592; G06Q 40/08

(57) ABSTRACT

A system, method and program product for cost attribution using multiple factors, in which transactional data sets from two or more time periods are analyzed based on multiple potential factors in the data sets that can be correlated to cost. The potential factors are systematically analyzed to identify a set of cost factors and compute the cost impact for each cost factor. An infrastructure is disclosed having a data selection system; a potential factors system; a factor hierarchy system; an actionability class system; a factor processing system and a cost factor reporting system for providing the cost impact of the set of cost factors based on analysis of the transactional data sets.

### TECHNICAL FIELD

The subject matter of this invention relates to business intelligence tools, and more particularly to a system and method for analyzing multiple factors and combinations of factors to attribute changes in costs over time using large transactional data sets.

### BACKGROUND

With increasing volumes of transactional data available to companies, there is a desire to improve actionable business intelligence based on these large transactional data sets. Many companies employ a business intelligence platform to collect, organize, and use operational data from the business, as well as publicly available and licensed third party databases, to drive business decision-making. In addition to business intelligence systems maintained by large companies, small-to-mid-sized companies may be able to access hosted business intelligence systems and/or have consultants use their business intelligence tools to analyze the companies' databases. Improving business intelligence tools and the automation and insights they provide for specific business challenges is an area of continued technological innovation.

One such business challenge is the allocation of changing costs in the delivery of goods or services from one time period to another. In order to make operational, policy, or product/service changes that are responsive to the realities of these cost changes, the business needs to be able to accurately allocate the cost changes to one or more factors driving the change. Due to the size and complexity of the transactional data sets and the often complex relationships among factors, a business intelligence tool is needed to effectively analyze and quantify the cost factors.

For example, healthcare costs change over time according to a complex set of factors. Health insurance companies, being broadly exposed to these costs at an institutional scale, are particularly interested in monitoring changes in their costs and understanding their causes, whether related to healthcare provider practices, patient health and risk profiles, changes in government policy and regulations, or internal company operations. This gives rise to the problem of cost change attribution, the task of identifying and quantifying factors most responsible for changes in an entity's costs.

Insights into the drivers of cost change enable insurance companies to proactively manage their operations. For example, once a change in medical practices has been discovered, an insurer can quickly respond by updating its benefit coverage policies. Alternatively, the insurer can be better prepared for contract negotiations with providers in an effort to hold down key costs. Despite the numerous benefits, cost change attribution has traditionally been done in an ad-hoc, selective manner. An insurance company might focus on cost increases for a specific group of medical procedures or group of providers. Analyses that are narrowly predefined may miss large parts of the full picture given the range of factors that an insurer can consider. Moreover, notwithstanding attempts to control for certain factors to isolate the effects of others, unexpected interactions can arise. A more systematic, large-scale method for healthcare cost change attribution is desirable. The use of rich transactional data sets coupled with more sophisticated analytics creates the potential for much more comprehensive understanding of healthcare costs.

### SUMMARY

The present disclosure provides a system and method for cost attribution using multiple factors, in which transactional data sets from two or more time periods are analyzed based on multiple potential factors in the data sets that can be correlated to cost. The potential factors are systematically analyzed to identify a set of cost factors and compute the cost impact for each cost factor.

A first aspect provides a cost attribution system running on a computing system with a processor and memory, comprising: a system for accessing a first transactional data set for a first time period including cost data for the first time period; a system for accessing a second transactional data set for a second time period including cost data for the second time period; a system for identifying a plurality of potential factors present in the first transactional data set and the second transactional data set that can be correlated to cost; and a factor processing system analyzing the plurality of potential factors in relation to the first transactional data set and the second transactional data set to identify a set of cost factors from the plurality of potential factors and to compute a cost impact for each cost factor in the set of cost factors.

A second aspect provides a computer program product stored on computer readable storage medium, which when executed by a computing system provides a cost attribution system, comprising: program instructions for accessing a first transactional data set for a first time period including cost data for the first time period; program instructions for accessing a second transactional data set for a second time period including cost data for the second time period; program instructions for identifying a plurality of potential factors present in the first transactional data set and the second transactional data set that can be correlated to cost; and program instructions for analyzing the plurality of potential factors in relation to the first transactional data set and the second transactional data set to identify a set of cost factors from the plurality of potential factors and to compute a cost impact for each cost factor in the set of cost factors.

A third aspect provides a computerized method of providing a cost attribution system, comprising: accessing a first transactional data set for a first time period including cost data for the first time period; accessing a second transactional data set for a second time period including cost data for the second time period; identifying a plurality of potential factors present in the first transactional data set and the second transactional data set that can be correlated to cost; iteratively calculating a set of cost factors with variable coefficients using a statistical model based upon multiplicative relationships among the plurality of potential factors applied to the first transactional data set and the second transactional data set until the set of cost factors and the variable coefficients stabilize; computing a cost impact for each cost factor in the set of cost factors.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computing system having a cost attribution system according to embodiments.

FIG. 2 shows a method flow of a cost attribution system according to embodiments.

FIG. 3 shows a method flow for iteratively calculating cost impacts according to embodiments.

FIG. 4 shows equations used in an example statistical model according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

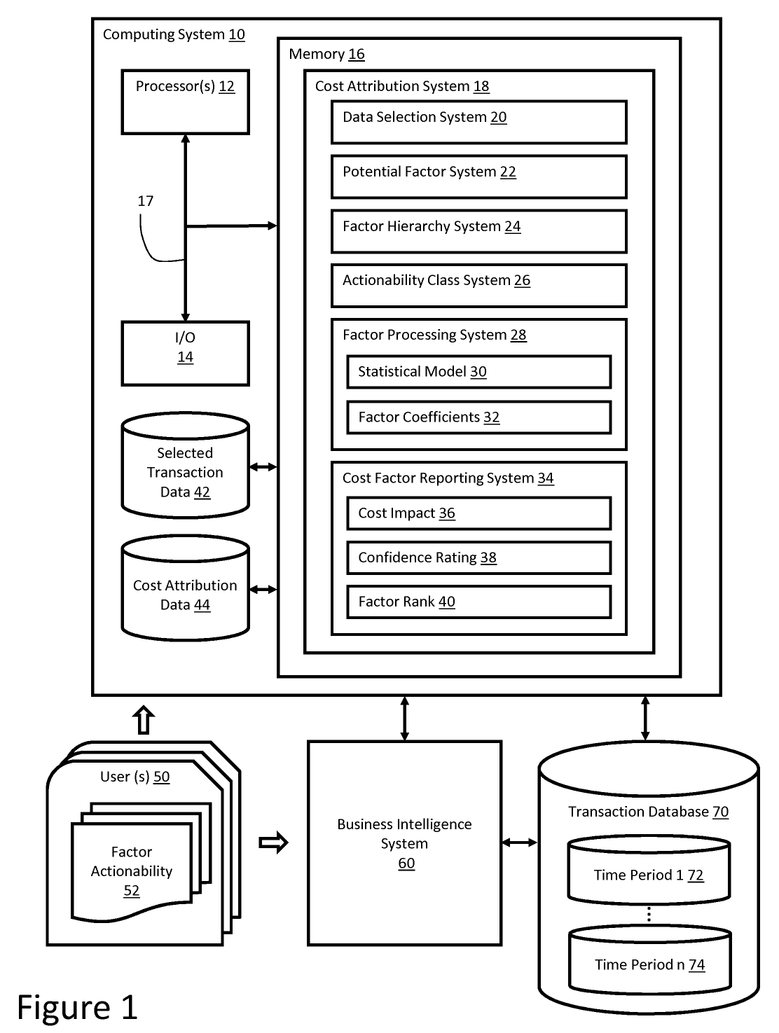

Referring now to the drawings, FIG. 1 depicts a computing system 10 having a cost attribution system 18 that provides a business intelligence tool for analyzing cost changes and reporting cost factors and their cost impact. Users 50 access the cost attribution system 18 on computing system 10 directly or as a feature, module, tool, or companion application available through a business intelligence system 60. The cost attribution system 18 analyzes transactional data from two or more time periods for calculating cost changes and attributing cost impacts to various factors. The cost attribution system 18 retrieves the transaction data from a transaction database 70 for each time period of interest, such as time period 1 72 through time period n 74. For example, the transaction data may be retrieved using database queries directly to a database management system associated with transaction database 70 or through the business intelligence system 60. The transaction data for the time periods of interest may be stored in a repository on a storage device associated with the computing system 10, such as selected transaction data 42. Similarly, interim calculation data and resulting cost factors may be stored within the computing system 10 in cost attribution data 44.

Cost attribution system 18 generally includes: a data selection system 20, a potential factor system 22, a factor hierarchy system 24, an actionability class system 26, a factor processing system 28, and a cost factor reporting system 34. The factor processing system 28 generally includes a statistical model 30 and variable factor coefficients 32. The cost factor reporting system 34 generally includes cost impact 36, confidence ratings 38, and factor rank 40.

The data selection system 20 may for example include a mechanism for enabling the selection of specific data sets and time periods of interest for performing the cost attribution analysis. For example, the data selection system 20 may provide a graphical user interface that enables users 50 to identify the transaction data repository, such as transaction database 70, to use for the analysis, as well as two or more time periods for analysis. Users 50 may be able to use standard data definition and retrieval tools provided by the business intelligence system 60 or a database management system to define and access the desired data sets. Alternately, the data selection system 20 may be configured to automatically select and access transactional data sets on a periodic basis per time or event driven workflows within the cost attribution system 18 or business intelligence system 60, for example, daily, weekly, monthly, quarterly, or annual comparisons against the immediately prior period or the same period from a prior year.

The potential factor system 22 may for example include a mechanism for identifying all potential factors that are present in the selected transaction data sets that could possibly correlate to a cost change. In addition to the data categories obviously present in the fields of the data set, the potential factor system 22 may also include additional data sources for categorizing or combining data present in the data sets. For example, date or time information may be aggregated or otherwise manipulated into various potential factors, geographic information may be aggregated or transformed based on known geographic classification systems, or provider, procedure, medication, device, or insurance codes may be associated with more robust data based on lookup tables or other cross-references. For example, in the context of a health insurance analysis, potential factor system 22 may include a complete list of potential health insurance cost factors present in a company's transaction database 70, potentially supplemented with standard definitions from industry or government regulatory standards. Such potential health insurance cost factors could include claim information, patient identifiers, demographics, insurance plan benefits, insurance plan coverage, event dates, procedures, diagnoses, locations, prescribing providers, provider group, and specialties. As another example, in the context of changes in company sales over time in the context of input costs, potential factor system 22 may include a complete list of cost factors merging the sales and operational cost tracking databases in a company's transaction database 70, potentially supplemented with industry, regulatory, market, and economic data for additional context. Such potential sales cost factors could include direct sales and marketing costs, personnel, customer information, geography, demographics, channel information, competition, general and local economics, and product or service characteristics. As another example, in the context of property and casualty insurance cost attribution, potential factor system 22 may include a complete list of fields tracked in the claims and policy data in the company's transaction database 70, potentially supplemented with industry, regulatory, market, and economic data for additional context. Such potential property/casualty insurance cost factors could include adverse event characteristics (e.g., damage level, damage type), covered entity features (e.g., property type, size, luxury factors), location-specific features (e.g., weather, crime rate), etc.

The factor hierarchy system 24 may for example include a mechanism for organizing the potential factors from potential factor system 22 according to one or more factor hierarchies. Factor hierarchies may include multilevel classes and subclasses used for categorizing, aggregating, and disaggregating information. For example, geographic information can be analyzed at site, city, region, state, national, and similar hierarchical breakdowns. Provider information can go from individuals to groups to hospitals to networks. Procedure, specialty, device, medication, patient demographics, and insurance product information may also nest into hierarchical terms. In some transactional databases, there may be variance in what hierarchical level transaction data is recorded, providing an advantage to systems able to manage the hierarchical relationships and their potentially complex interactions. The factor hierarchy system 24 may not be used to simply normalize data, but to enable parallel analysis of how a given factor and its sub-factors and super-factors within a hierarchy all contribute to cost impact so that they may be weighed against each other and provide a more nuanced cost factor output. The factor hierarchy system 24 may provide built in regularization which encourages the cost attribution system 18 to attribute cost changes to higher level factors where appropriate. For example, if cost increase is observed in a significant portion of physicians who perform a procedure, the procedure, rather than the physicians, would be identified as the cost factor with cost impact.

The actionability class system 26 may for example include a mechanism for classifying potential factors according to their actionability within the context of the business performing the cost attribution analysis. For example, the users 50 may possess experience and knowledge of business operations that enable them to define factor actionability 52 for various factors present in potential factor system 22. Factor actionability may also be defined at an organization or other level for one or more potential factors and built into the cost attribution system 18 without further input from the users 50. Actionability classes are based upon the observation that usefulness of cost attribution depends not only on accuracy, but also on actionability. However, the exact tradeoff between accuracy and actionability may be difficult to determine a priori and it may be desirable for some cost attribution systems to enable flexible, real-time incorporation of tacit knowledge of users 50. System and/or user defined actionability classes allow quantification of an actionability modifier for selected potential cost factors and may be adjustable based on iterative use of cost attribution system 18 and adjusting the actionabilty modifier for a given potential cost factor or group of cost factors.

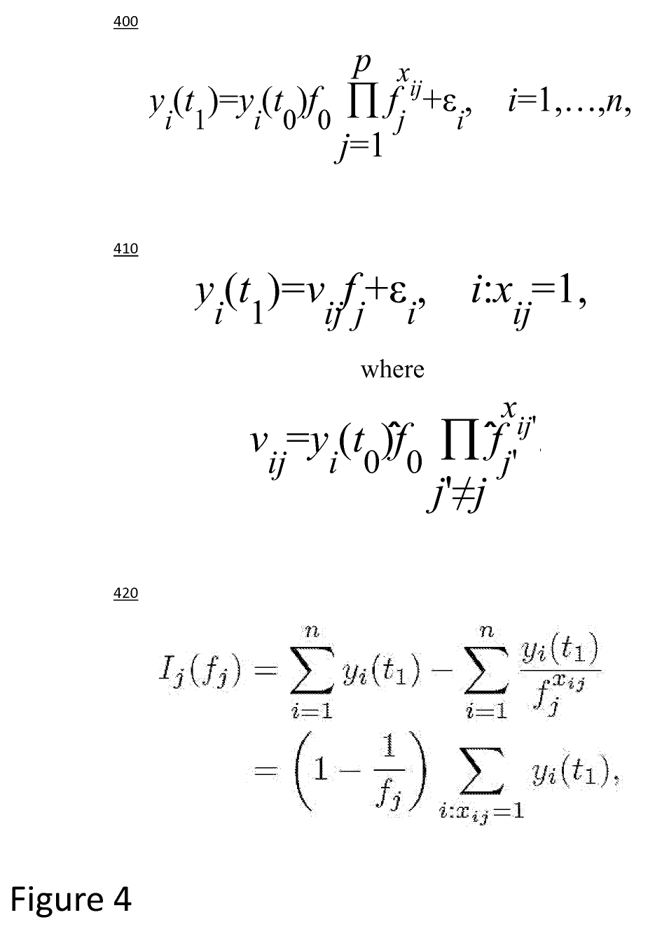

The factor processing system 28 may for example include a mechanism for calculating the relevant factors from the potential factor system 22 in light of factor hierarchy system 24 and actionability class system 26. The factor processing system 28 uses a statistical model 30 to iteratively calculate factor coefficients 32 related to each of the potential factors with the objective of eliminating unnecessary factors and quantifying the cost impact of the remaining factors. The statistical model 30 may include any statistical algorithm intended to accurately estimate the relationships among the multiple potential factors. For example, a multiplicative model has been shown to provide accurate results in the context of health insurance cost attribution. The multiplicative equation 400 in FIG. 4 provides an example statistical model using paired cost samples yᵢ(t₀), yi(t₁), i=1, . . . , n, for time periods t₀ and t₁. f₀ is an overall inflation (or deflation) factor, fⱼ, j=1, . . . , p, is a coefficient representing the effect of factor j, xᵢⱼ is a binary-valued indicator with xᵢⱼ=1 if factor j is present in sample i and xᵢⱼ=0 otherwise, and εᵢ is additive error. All coefficients f₀, . . . , fₚ may be assumed to be positive. While each index j may be referred to as a factor for convenience, some indices may actually correspond to combinations of factors, for example a provider group combined with a procedure group. Other linear, non-linear, logarithmic, or complex models for defining the relationships among factors may also be possible. The use of factor coefficients 32 and a method of iteratively estimating and calculating the factor coefficients for each potential factor until a stable set of factor coefficients is reached may drive the factor processing system 28. The ability to calculate confidence values for the calculated factor coefficients may also be a feature of the factor processing system 28. For example using confidence equation 410 in FIG. 4, once the coefficients have been estimated, corresponding confidence measures may be computed. A linear approximation to multiplicative equation 400 is used in which all but one of the coefficients are fixed to their estimated values, i.e. f_{j′}=\hat{f}_{j′} for j′≠j, resulting in a linear model in the remaining coefficient fⱼ. Then the standard error of \hat{f}ⱼ is computed by applying known formulas for simple (single-variable) linear regression to the confidence equation 410. Determining the factor coefficients and confidences for the relevant set of cost factors enables the factor processing system 28 to calculate the resulting cost impacts. There are many ways that cost impact could be calculated based upon the assumptions of a specific organization or cost methodology. Cost impact equation 420 in FIG. 4 shows an example cost impact calculation. For each factor j, the difference between the total actual cost in period t₁ and the same cost is calculated, but assuming that fⱼ=1, i.e., the factor has no effect. The second equality in cost impact equation 420 follows because xᵢⱼ is binary. The cost impact equation 420 produces the cost impact of factor j and is proportional to the sum of the costs involving that factor. In addition to the base relationships among factors and the additional factor modifications based on factor hierarchy system 24 and actionability class system 26, the statistical model 30 may take other known characteristics of the cost system being modeled in order to further provide accurate results. For example, changes in taxonomy, external market, data reporting, or other process-related changes, may be incorporated into special modifiers or limits on the statistical model 30. Incorporating a measure of global cost increases or a methodology for correcting for payment processing speed are examples of these special modifiers that can be built into the statistical model 30. Given the complex data sources, factor relationships, and statistical models, it may be advantageous to dynamically adjust noise estimations as variable thresholds within the factor processing system 28 to control false positive or false discovery rates within groups of related factors. For example, users 50 may be able to adjust the noise threshold for a given factor or group of factors between iterations with the factor processing system 28 to better determine whether the potential cost factors are significant or not. Operation of the factor processing system 28 utilizing the factor hierarchy system 24 and actionability class system 26 improve explanatory power by directly minimizing errors between explained and actual cost trends, without complex statistical transformations that may be more difficult for users 50 to understand.

The cost factor reporting system 34 may for example include a mechanism for calculating the cost impact 36, confidence rating 38, and factor rank 40 based upon the stabilized factor coefficients 32 from statistical model 30. The cost impact 36 may be quantified in monetary or cost percentage terms relative to the total cost change between the time periods of the transactional data sets. For example, the cost factor reporting system 34 may report a direct cost value for each relevant cost factor for time period 1 and time period 2, along with the cost impact 36 estimated for the change in direct cost values, along with confidence rating 38. The cost factor reporting system 34 may also provide the factor coefficient 32 from statistical model 30. The relevant cost factors (that were not eliminated by the factor processing system 28) may be arranged in order of factor rank 40 based upon their cost impact 36 and confidence rating 38 and/or assigned an index value for their rank position, generally from most impact to least. Factor prioritization based upon both confidence and estimated impact supports more effective business decision-making. The cost factor reporting system 34 may provide a graphical user interface for receiving the reported information or it may be output through another device or system, such as display through business intelligence system 60. The information reported by the cost factor reporting system 34 may be stored, manipulated, or further incorporated into business intelligence processes or workflows by the business intelligence system 60.

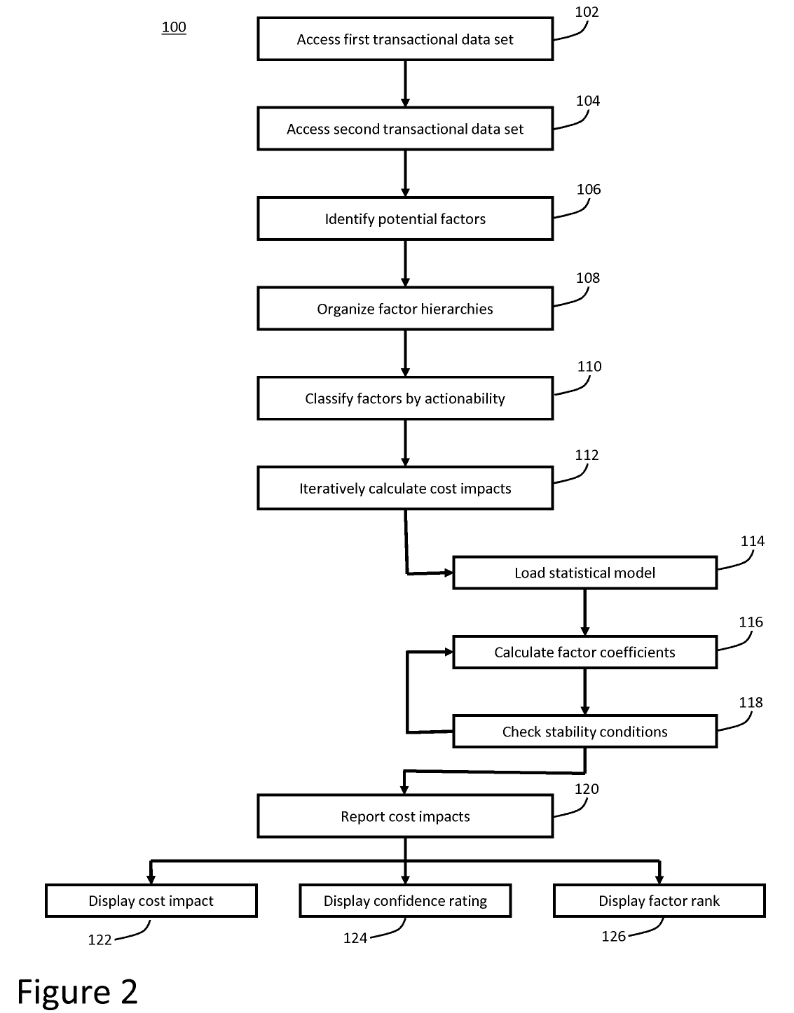

FIG. 2 depicts a flow diagram of a method 100 of providing a cost attribution as described herein. At 102, the cost attribution system 18 accesses a first transactional data set, such as a historical transactional data set. Next, at 104, the cost attribution system 18 accesses a second transactional data set, such as a current transactional data set for a similar period to the historical transaction data set. At 106, the cost attribution system 18 identifies a multitude of potential factors from the selected data sets for consideration for cost attribution. At 108, the potential factors are organized into factor hierarchies, such as by accessing predefined hierarchies in the cost attribution system 18, importing hierarchies from the business intelligence system 60 or an industry resource, or enabling users 50 to organize the potential factors into factor hierarchies based on a known or desired taxonomy. At 110, the potential factors are classified by actionability, such as by accessing predefined classification schemes in the cost attribution system 18, importing hierarchies from the business intelligence system 60, or enabling users 50 to organize potential factors into actionability classes based on user experience. At 112, the cost attribution system 18 iteratively calculates cost impact by loading a statistical model at 114, calculating factor coefficients through estimation for all relevant potential factors at 116, and checking stability conditions at 118, iterating through factor coefficient calculations at 116 until the stability conditions are met and the method 100 can proceed. At 120, the cost attribution system 18 calculates and reports cost impacts for each cost factor, adjusted for statistical confidence, and displays a cost impact value at 122, a confidence rating at 124, and a factor rank at 126 based on an overall score. Upon reviewing the reported results, users 50 may choose to repeat steps 112-126 with the cost attribution system 18 while varying one or more factor modifiers or actionability classes based on user preferences and hypotheses regarding cost attribution.

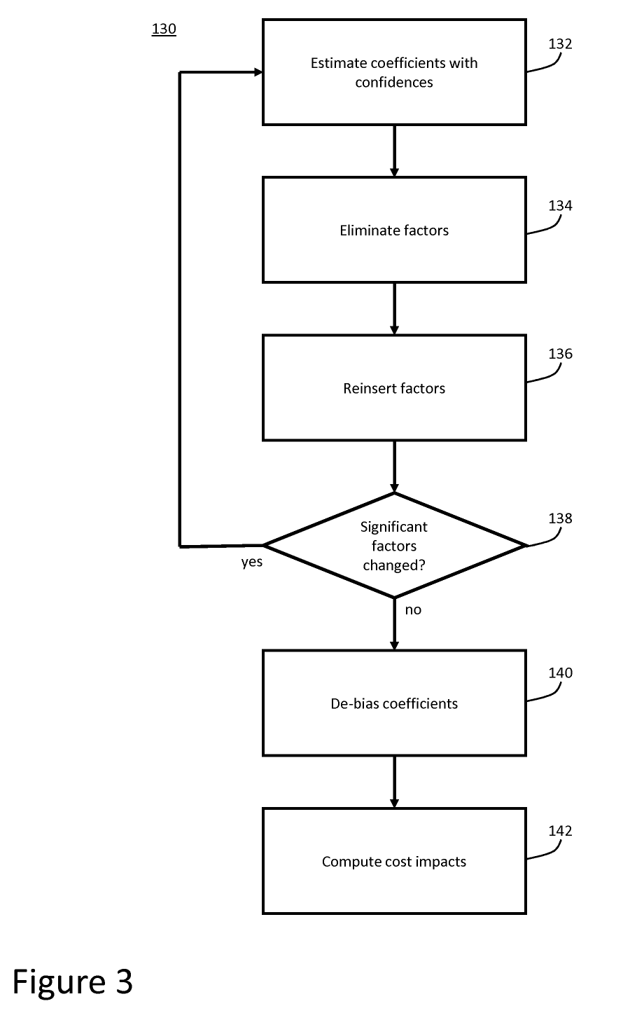

FIG. 3 depicts a flow diagram of an example method 130 of iteratively calculating cost impacts using the statistical model 30 and the factor coefficients 32 as described herein. In this example, each of the factor coefficients 32 are estimated, eliminated or reinserted, and re-estimated until the coefficient values stabilize. At 132, the factor coefficients are estimated with confidence values. The relationship between the independent variables (factors) and dependent variable (cost) can take different forms depending on the statistical model being used, such as multiplicative relationships. Regularization parameters can be assigned to factors based upon the actionability class or other relevant preferences. At 134, factors are eliminated if they appear unnecessary to account for the costs. For example, significance tests can be conducted and factors eliminated accordingly. The relationships defined in the factor hierarchy can be considered in the significance testing to enable the cost attribution system to correctly allocate among hierarchically related factors. At 136, factors that were eliminated in previous iterations can be re-estimated, reinserted, and subjected to significance testing to assure that factors are not missed when future iterations adjust relevant relationships. At 138, the significant factors are tested to see whether they have changed from the prior iteration. If yes, then the method 130 returns to 132 and estimates coefficients with confidences again. If no, then the method 130 proceeds to finalize the factor coefficients and compute the final cost impacts. In 140, the factor coefficients are de-biased to produce the final estimation of factor coefficients and the related statistical confidence value. In 142, cost impacts are calculated based on the final factor coefficients for the relevant set of cost factors identified in method 130.

Cost attribution system 18 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 depicts an illustrative computing system 10 that may comprise any type of computing device and, and for example includes at least one processor 12, memory 16, an input/output (I/O) 14 (e.g., one or more I/O interfaces and/or devices), and a communications pathway 17. In general, processor(s) 12 execute program code which is at least partially fixed in memory 16. While executing program code, processor(s) 12 can process data, which can result in reading and/or writing transformed data from/to memory and/or I/O 14 for further processing. The pathway 17 provides a communications link between each of the components in computing system 10. I/O 14 can comprise one or more human I/O devices, which enable a user to interact with computing system 10.

Furthermore, it is understood that the cost attribution system 18 or relevant components thereof (such as an API component, item recognition system, user Apps, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will, select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A cost attribution system running on a computing system with a processor and memory, comprising:
a system for accessing a first transactional data set for a first time period including cost data for the first time period;
a system for accessing a second transactional data set for a second time period including cost data for the second time period;
a system for identifying a plurality of potential factors present in the first transactional data set and the second transactional data set that can be correlated to cost; and
a factor processing system analyzing the plurality of potential factors in relation to the first transactional data set and the second transactional data set to identify a set of cost factors from the plurality of potential factors and to compute a cost impact for each cost factor in the set of cost factors.

2. The system of claim 1, further comprising a system for organizing the plurality of potential factors into a plurality of factor hierarchies and wherein the plurality of factor hierarchies are used by the factor processing system to identify the set of cost factors.

3. The system of claim 1, wherein the factor processing system computes a confidence rating for each cost factor in the set of cost factors.

4. The system of claim 1, wherein the factor processing system computes a ranking for each cost factor in the set of cost factors.

5. The system of claim 1, further comprising a system for classification of the plurality of potential factors into a plurality of actionability classes and wherein the plurality of actionability classes are used by the factor processing system to identify the set of cost factors from the plurality of potential factors and to compute the cost impact for each cost factor in the set of cost factors.

6. The system of claim 1, wherein the factor processing system uses a statistical model for iterative calculation of the set of cost factors based upon multiplicative relationships among the plurality of potential factors.

7. The system of claim 1, wherein the first transactional data set and the second transactional data set include a plurality of insurance claims with cost data and data correlating to the plurality of potential factors, wherein the plurality of potential factors are chosen from claim information, patient identifiers, demographics, insurance plan benefits, insurance plan coverage, event dates, procedures, diagnoses, prescriptions, locations, providers, provider group, and specialties.

8. A computer program product stored on computer readable storage medium, which when executed by a computing system provides a cost attribution system, comprising:
program instructions for accessing a first transactional data set for a first time period including cost data for the first time period;
program instructions for accessing a second transactional data set for a second time period including cost data for the second time period;
program instructions for identifying a plurality of potential factors present in the first transactional data set and the second transactional data set that can be correlated to cost; and
program instructions for analyzing the plurality of potential factors in relation to the first transactional data set and the second transactional data set to identify a set of cost factors from the plurality of potential factors and to compute a cost impact for each cost factor in the set of cost factors.

9. The computer program product of claim 8, further comprising program instructions for organizing the plurality of potential factors into a plurality of factor hierarchies and wherein the plurality of factor hierarchies are used to identify the set of cost factors.

10. The computer program product of claim 8, further comprising program instructions for computing a confidence rating for each cost factor in the set of cost factors.

11. The computer program product of claim 8, further comprising program instructions for computing a ranking for each cost factor in the set of cost factors.

12. The computer program product of claim 8, further comprising program instructions for classifying the plurality of potential factors into a plurality of actionability classes and wherein the plurality of actionability classes are used to identify the set of cost factors from the plurality of potential factors and to compute the cost impact for each cost factor in the set of cost factors.

13. The computer program product of claim 8, further comprising program instructions for iterative calculation of the set of cost factors using a statistical model based upon multiplicative relationships among the plurality of potential factors.

14. The computer program product of claim 8, wherein the first transactional data set and the second transactional data set include a plurality of insurance claims with cost data and data correlating to the plurality of potential factors, wherein the plurality of potential factors are chosen from claim information, patient identifiers, demographics, insurance plan benefits, insurance plan coverage, event dates, procedures, diagnoses, prescriptions, locations, providers, provider group, and specialties.

15. A computerized method of providing a cost attribution system, comprising:
accessing a first transactional data set for a first time period including cost data for the first time period;
accessing a second transactional data set for a second time period including cost data for the second time period;
identifying a plurality of potential factors present in the first transactional data set and the second transactional data set that can be correlated to cost;
iteratively calculating a set of cost factors with variable coefficients using a statistical model based upon multiplicative relationships among the plurality of potential factors applied to the first transactional data set and the second transactional data set until the set of cost factors and the variable coefficients stabilize;
computing a cost impact for each cost factor in the set of cost factors.

16. The method of claim 15, further comprising organizing the plurality of potential factors into a plurality of factor hierarchies and wherein the plurality of factor hierarchies are used in the statistical model.

17. The method of claim 15, further comprising computing a confidence rating for each cost factor in the set of cost factors.

18. The method of claim 15, further comprising computing a ranking for each cost factor in the set of cost factors.

19. The method of claim 15, further comprising classifying the plurality of potential factors into a plurality of actionability classes and wherein the plurality of actionability classes are used to iteratively calculate the set of cost factors and to compute the cost impact for each cost factor in the set of cost factors.

20. The system of claim 15, wherein the first transactional data set and the second transactional data set include a plurality of insurance claims with cost data and data correlating to the plurality of potential factors, wherein the plurality of potential factors are chosen from claim information, patient identifiers, demographics, insurance plan benefits, insurance plan coverage, event dates, procedures, diagnoses, prescriptions, locations, providers, provider group, and specialties.
